(19) United States
(12) Patent Application Publication
(10) Pub. No.: US 2015/0170811 A1
(43) Pub. Date: Jun. 18, 2015

(54) FERRITE MAGNETIC MATERIAL, FERRITE SINTERED MAGNET, AND MOTOR

(71) Applicant: TDK CORPORATION, Tokyo (JP)

(72) Inventors: Naoharu Tanigawa, Tokyo (JP); Yoshihiko Minachi, Tokyo (JP); Yasumi Takatsuka, Tokyo (JP); Kazuto Makita, Tokyo (JP)

(73) Assignee: TDK CORPORATION, Tokyo (JP)

(21) Appl. No.: 14/414,579

(22) PCT Filed: Aug. 1, 2013
(86) PCT No.: PCT/JP2013/070895

§ 371 Date: Jan. 13, 2015

(30) Foreign Application Priority Data
Aug. 1, 2012 (JP) 2012-170847

(51) Int. Cl. H01F 1/10; C22C 38/00; C22C 38/10; H01F 1/055; C04B 35/26

(52) U.S. Cl. CPC H01F 1/10; H01F 1/0557; C04B 35/2675; C22C 38/10; C22C 38/005; C22C 38/002

(57) ABSTRACT

A ferrite magnetic material and ferrite sintered magnet composed thereof have a ferrite having a hexagonal crystal structure as a main component. A composition ratio of a metallic element included in the main component is represented by: RₓA₁₋ₓ(Fe_{12-y}Co_{y})_{z}. R is at least one element selected from La, Ce, Pr, Nd and Sm and at least includes La. A is at least two elements selected from Ca, Sr and Ba and at least includes Ca and Sr. Si component and either or both of Al component and Cr component are included as a sub-component. When a sum of Al content and a value obtained by dividing Cr content by four and a value obtained by calculating the formula [(R+A)−(Fe+Co)/12]/Si where R, A, Fe, Co and Si indicate values of each atom % thereof are defined as L and G, respectively, L and G have to be values within a predetermined region.

### TECHNICAL FIELD

The present invention relates to a ferrite magnetic material, a ferrite sintered magnet composed of the ferrite magnetic material, and a motor using the ferrite sintered magnet.

### BACKGROUND ART

Ferrite sintered magnets are widely used for such as electromotor carried on electric home appliances, automobiles and the like. The ferrite sintered magnets are generally manufactured using a magnetoplumbite-type Sr ferrite or Ba ferrite having a hexagonal crystal structure as a source material. The magnetoplumbite-type Ba or Sr ferrite is often referred to as Magnetoplumbite-type ferrite or M-type ferrite. The M-type ferrite is represented by the formula AFe₁₂O₁₉, and an element constituting A site is selected from Ba, Sr and Pb.

There is disclosed a ferrite sintered magnet including Ca as an element constituting A site and at least La as a rare-earth element (for example, see Patent Literature 1). Patent Literature 1 discloses that the ferrite sintered magnet including both a ferrite phase having a magnetoplumbite structure of hexagonal crystal whose composition ratio is represented by the following formula and a grain boundary phase including Si as an essential component has a high coercive force HcJ and a high residual magnetic flux density Br, and is excellent in magnetic properties.

Ca_{1-x-y}RₓA_{y}Fe_{2n-z}Co_{z} Formula:

wherein,
R element is at least one of rare earth elements and necessarily includes La,
A element is at least one of Sr and Ba,
1-x-y, x, y and z representing atomic ratios of each element and n representing a molar ratio satisfy the following conditions:
0.3≦1-x-y≦0.65;
0.2≦x≦0.65;
0≦y≦2.0;
0.03≦z≦0.65; and
4≦n≦7.

There is also known that the addition of alumina (Al₂O₃) or chromium oxide (Cr₂O₃) is effective to obtain ferrite sintered magnets having a high coercive force HcJ and excellent magnetic properties (for example, see Patent Literatures 2 and 3).

However, mere increase of addition amount of Al, Cr or both thereof upon manufacturing ferrite sintered magnets having the above composition is not enough to enhance a coercive force HcJ and causes a large decline of residual magnetic flux density Br. Then, it is difficult to achieve excellent magnetic properties.

### CITATION LIST

Patent Literature 1: International Laid-Open WO2011-001831
Patent Literature 2: JP Patent Application Laid-Open No. 2000-277312
Patent Literature 3: JP Patent Application Laid-Open No. 2007-210876

### SUMMARY OF INVENTION

### Problem to be Solved by the Invention

The present invention has been accomplished in consideration of the above background arts, and objects thereof are to provide a ferrite magnetic material excellent in magnetic properties with a high coercive force HcJ of 477 kA/m or more and a high residual magnetic flux density Br of 330 mT or more, a ferrite sintered magnet composed of the ferrite magnetic material, and a motor using the ferrite sintered magnet.

### Means to Solve the Problem

In order to achieve such objects, the present inventors have earnestly investigated a ferrite magnetic material, a ferrite sintered magnet and a motor. Consequently, they have focused on the fact that mere addition of Al or Cr used as a sub component does not lead to sufficient improvement in magnetic properties of resulting ferrite sintered magnets because it is insufficient for improving a coercive force HcJ and causes decline of residual magnetic flux density Br. In order to obtain a ferrite sintered magnet having a higher coercive force HcJ, the present inventors have also focused on a relation between a content (mass %) of Al and/or Cr and a value obtained by calculating the formula [(R+A)−(Fe+Co)/12]/Si where R, A, Fe, Co and Si indicate values of each atom % thereof. After the earnest investigation on this matter, the present inventors have found that adjustment of a balance between the content of Al and/or Cr and the value obtained by calculating [(R+A)−(Fe+Co)/12]/Si leads to further improvement on coercive force HcJ of resulting ferrite sintered magnets. The present invention has been accomplished based on such knowledge.

In the present invention, there is provided a ferrite magnetic material comprising a ferrite having a hexagonal crystal structure as a main component, wherein

metal element composition included in the main component is represented by the composition formula: RₓA₁₋ₓ(Fe_{12-y}Co_{y})_{z}, where
R is at least one element selected from the group consisting of La, Ce, Pr, Nd and Sm, and at least includes La,

A is at least two elements selected from the group consisting of Ca, Sr and Ba, and at least includes Ca and Sr, and

x, y and z satisfy the following conditions:

0.3≦0.6;

8.0≦12z≦10.1; and

1.32≦x/yz≦1.96,

Si component and Al component and/or Cr component are included as a sub component in addition to the main component, and

L and G are values within a region surrounded by the points shown as a: (0.20, 2.30), b: (2.15, 0.30), c: (2.50, 0.30) and d: (1.50, 2.30) placed on (x, y) coordinate where said L and G are shown on x-axis and y-axis, respectively, wherein,

L is a sum of content (mass %) of Al component in terms of Al₂O₃ and a value obtained by dividing content (mass %) of Cr component in terms of Cr₂O₃ by four and

G is a value obtained by calculating the formula [(R+A)−(Fe+Co)/12]/Si where R, A, Fe, Co and Si indicate values of each atom % thereof.

As for the A element in the composition formula, an atomic ratio of Ca and Sr is preferably within a range satisfying the formula 1.8≦Ca/Sr≦3.7. When Ca/Sr ratio is within the range, the effect of the present invention can be further enhanced.

As for the A element in the composition formula, an atomic ratio of Ba and Sr is preferably within a range satisfying the formula Ba/Sr≦2.0. When Ba/Sr ratio is within the range, the effect of the present invention can be enhanced.

The ferrite sintered magnet according to the present invention comprises a ferrite sintered magnet comprising a ferrite having a hexagonal crystal structure as a main component, wherein

metal element composition included in the main component is represented by the composition formula: RₓA₁₋ₓ(Fe_{12-y}Co_{y})_{z}, where

R is at least one element selected from the group consisting of La, Ce, Pr, Nd and Sm, and at least includes La,

A is at least two elements selected from the group consisting of Ca, Sr and Ba, and at least includes Ca and Sr, and

x, y and z satisfy the following conditions:

0.3≦x≦0.6;

8.0≦12z≦10.1; and

1.32≦x/yz≦1.96,

Si component and Al component and/or Cr component are included as a sub component in addition to the main component, and

L and G are values within a region surrounded by the points shown as a: (0.20, 2.30), b: (2.15, 0.30), c: (2.50, 0.30) and d: (1.50, 2.30) placed on (x, y) coordinate where said L and G are shown on x-axis and y-axis, respectively, wherein,

L is a sum of content (mass %) of Al component in terms of Al₂O₃ and a value obtained by dividing content (mass %) of Cr component in terms of Cr₂O₃ by four and

G is a value obtained by calculating the formula [(R+A)−(Fe+Co)/12]/Si where R, A, Fe, Co and Si indicate values of each atom % thereof.

As for the A element in the composition formula, an atomic ratio of Ca and Sr is preferably within a range satisfying the formula 1.8≦Ca/Sr≦3.7. When Ca/Sr ratio is within the range, the effect of the present invention can be further enhanced.

As for the A element in the composition formula, an atomic ratio of Ba and Sr is preferably within a range satisfying the formula Ba/Sr≦2.0. When Ba/Sr ratio is within the range, the effect of the present invention can be further enhanced.

According to the present invention, there is also provided a motor using said sintered magnet. The motor has further enhanced performance,

### Effects of the Invention

The ferrite magnetic materials of the present invention have good magnetic properties such as high coercive force HcJ of 477 kA/m or more and high residual magnetic flux density Br of 330 mT or more. The ferrite sintered magnets of the present invention composed of the ferrite magnet material also have good magnetic properties. Further, the motor of the present invention exhibits further improved performance.

### BRIEF DESCRIPTION OF DRAWINGS

FIG. 1 is a flow chart showing procedures for manufacturing a ferrite sintered magnet according to the present invention.

FIG. 2 is a figure showing the relation between L and G.

FIG. 3 is a figure showing the relation between the coercive force and the residual magnetic flux density.

FIG. 4 is a figure showing the relation between x and the coercive force.

FIG. 5 is a figure showing the relation between 12z and the coercive force.

FIG. 6 is a figure showing the relation between x/yz and the coercive force.

FIG. 7 is a figure showing the relation between Ca/Sr and the coercive force.

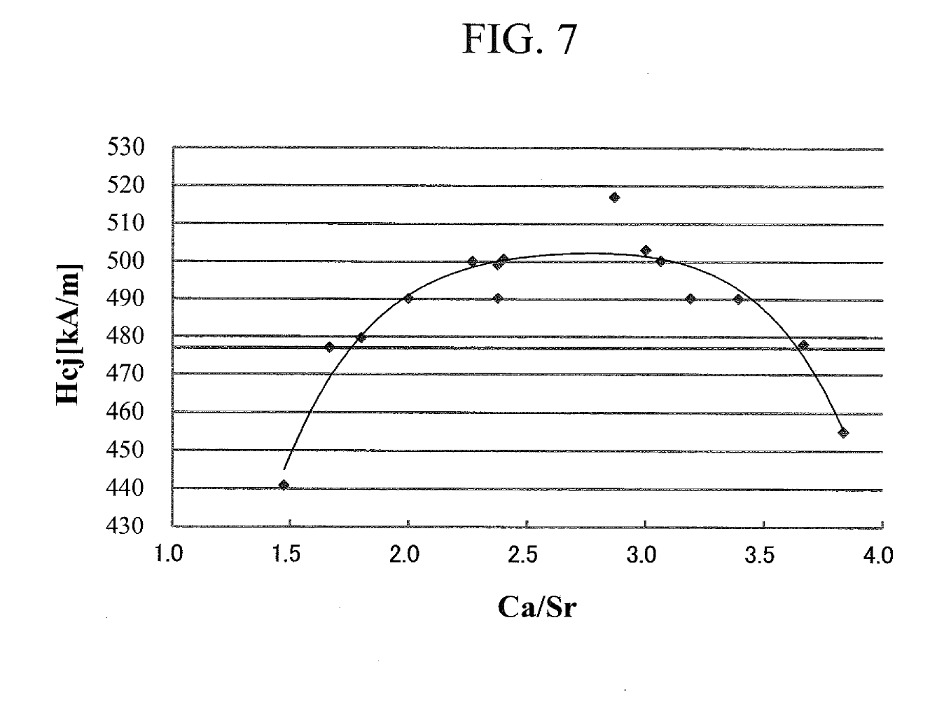

### DESCRIPTION OF EMBODIMENTS

The present invention will be described in detail with reference to the figures hereinafter. However, the present invention is not limited by the following description. Constituent elements of the present invention in the following description include ones easily arrived at by a person skilled in the art and ones considered being substantially the same or in the scope of equivalence. Further, each constituent element of the present invention set forth below can be appropriately combined.

### <Ferrite Magnetic Material>

A ferrite magnetic material according to the present embodiment (hereinafter, referred to as a ferrite magnetic material of the present embodiment) will be described. The ferrite magnetic material of the present embodiment includes a ferrite having a hexagonal crystal structure as a main component and the main component is preferably magnetoplumbite-type ferrite (M-type ferrite). The ferrite magnetic material can be manufactured as a powder or sintered body according to a method which necessarily includes a step of calcining a raw material composition obtained by mixing starting raw material powders.

The main component includes R, A, Fe and Co. R is at least one element selected from the group of La, Ce, Pr, Nd and Sm and at least includes La. In particular, R is preferred to solely include La in view of enhancing magnetic anisotropy field. A is at least one element selected from the group of Ca, Sr and Ba, and at least includes Sr.

A composition ratio of each metallic element of R, A, Fe, and Co included in the main component is represented by the following composition formula where x, 1-x, (12-y) z and yz show an atomic ratio of R, A, Fe and Co, respectively. The composition formula is represented according to the conventional method for showing the M-type ferrite except for omitting the indication of oxygen for simplification.

RₓA₁₋ₓ(Fe_{12-y}Co_{y})_{z} Composition Formula:

In the composition formula, an atomic ratio x of R is 0.3 to 0.6. When the atomic ratio x is within the above range, a ferrite magnetic material having improved residual magnetic flux density Br and coercive force HcJ is favorably obtained. When the atomic ratio x is too small, that is, the content of R is small, it becomes difficult to ensure a predetermined content of Co in a solid of M type ferrite, and thus residual magnetic flux density Br and coercive force HcJ of a resulting ferrite magnetic material become lower. On the other hand, when the atomic ratio x is too large, that is, the content of R is too large, residual magnetic flux density B of a resulting ferrite magnetic material decreases due to forming a non-magnetic phase (different phase) such as an orthoferrite including R. For such a perspective, the atomic ratio x is specified to be 0.3 to 0.6, preferably 0.33 to 0.55, and more preferably 0.35 to 0.53 in the present embodiment.

When z in the composition formula is too small, different phases including A and R are formed excessively. By contrast, when z is too large, different phases such as α-Fe₂O₃ phases or soft magnetic spinel ferrite phases including Co are formed excessively. Here, the total amount of Fe and Co is represented as 12z based on the composition formula, When 12z is within a predetermined range, it is possible to suppress deterioration of properties affected by the different phases to low levels. For such a perspective, 12z is specified to be 8.0 to 10.1, preferably 8.5 to 9.8, and more preferably 8.75 to 9.7 in the present embodiment.

A ratio of R and Co contained in the ferrite magnetic material is represented by x/yz which is specified to be 1.32 to 1.96, preferably 1.4 to 1.85, and more preferably 1.50 to 1.65.

A ratio of Ca and Sr used as the A element is preferably controlled to satisfy 1.8≦Ca/Sr≦3.7, more preferably 2.0≦Ca/Sr≦3.4, and further more preferably 2.3≦Ca/Sr≦3.1. When Ca/Sr ratio is within the above range, effects of the present invention can be further enhanced.

A ratio of Ba and Sr used as the A element is preferably controlled to satisfy Ba/Sr≦2.0, more preferably Ba/Sr≦1.0, and further more preferably Ba/Sr≦0.2. In the present embodiment, Ba is not necessary, and then Ba/Sr ratio is 0. When Ba/Sr ratio is within the above range, effects of the present invention can be further enhanced.

An atomic ratio (1-x) of A element in the composition formula is preferably 0.4 to 0.7. When the atomic ratio (1-x) of A element is within the above range, the improvement of residual magnetic flux density Br and coercive force HcJ are favorably obtained. When the atomic ratio (1-x) of A is too small, the atomic ratio x of R becomes large and the content of R becomes too large. Then, different phases such as orthoferrites including R are formed, consequently residual magnetic flux density Br and coercive force HcJ of a resulting ferrite magnetic material are decreased. On the other hand, when the atomic ratio (1-x) of A is too large, the atomic ratio x of R becomes small and the content of R becomes small. Then, residual magnetic flux density Br and coercive force HcJ of a resulting ferrite magnetic material become lower because it is difficult to ensure a predetermined content of Co in a solid of M type ferrite. For such a perspective, the atomic ratio (1-x) of A is 0.4 to 0.7, preferably 0.45 to 0.67, and more preferably 0.58 to 0.64.

An atomic ratio ((12-y) z) of Fe in the above composition formula is preferably 7.76 to 10.0. When the atomic ratio ((12-y) z) of Fe is within the above range, it is possible to prevent formation of different phases causing deterioration of magnetic properties. When the atomic ratio ((12-y) z) of Fe is too small, different phases including A and R tend to be formed. On the other hand, when the atomic ratio ((12-y) z) of Fe is too large, different phases such as α-Fe₂O₃ tend to be formed. From such a perspective, the atomic ratio ((12-y) z) of Fe is preferably from 7.76 to 10, more preferably 7.9 to 9.7, and further more preferably 8.1 to 9.5 in the present embodiment.

An atomic ratio (yz) of Co in the above composition formula is preferably 0.2 to 0.39. When the atomic ratio (yz) of Co is within the above range, it becomes possible to obtain the effect of improving magnetic properties because Co effectively replaces a part of Fe constituting M-type ferrite phase. When the atomic ratio (yz) of Co is too small, the effect of improving magnetic properties due to replacing a part of Fe with Co cannot be sufficiently obtained. On the other hand, when the atomic ratio (yz) of Co is too large, magnetic properties deteriorate because of exceeding the optimal point of electric charge balance between Co and R. From such a perspective, the atomic ratio (yz) of Co is preferably 0.2 to 0.39, more preferably 0.21 to 0.36, and further more preferably 0.23 to 0.34 in the present embodiment.

In order to obtain sufficient magnetic properties in the present embodiment, it is preferred that the ferrite magnetic material contains the main component in a range of 90 mass % or more, especially 95 or more to less than 100 mass %.

The ferrite magnetic material of the present embodiment includes at least Si component as a sub component, and besides it includes Al component and/or Cr component as a sub component. The sub component may be included either in a main phase or in a grain boundary of the ferrite magnetic material. In the present specification, components other than the main component in the ferrite magnetic material are considered as the sub component.

Si component to be used is not particularly limited as long as it contains Si element, and may be added as a compound such as SiO₂, Na₂SiO₃ or SiO₂.nH₂O. The addition of Si component to the ferrite magnetic material leads to favorable sinterability of the ferrite magnetic material, and to favorable control of magnetic properties due to adequately controlling a crystal particle size of sintered body. As a result, it becomes possible to maintain a good residual magnetic flux density Br while obtaining a high coercive force HcJ.

In the ferrite magnetic material of the present embodiment, content of Si component (total content of each Si component) is preferably 0.2 mass % to 4.0 mass %, more preferably 0.8 mass % to 3.6 mass % in terms of SiO₂. When the content of Si component is within the above range, high coercive force HcJ is obtained.

Al component to be used is not particularly limited as long as it contains Al element, and may be added as a compound such as Al₂O₃, Al₂SiO₃, or Al₂O₃.nH₂O to calcined substances composed of a main component upon pulverizing them to form calcined powders. The addition of Al component leads to favorable sinterability of the ferrite magnetic material, and to favorable control of magnetic properties due to adequately controlling a crystal particle size of sintered body. As a result, residual magnetic flux density Br can be favorably maintained while obtaining a high coercive force HcJ. Also, Al component is effective for suppressing variation in magnetic properties due to variation of conditions for manufacturing the ferrite magnetic material. In the ferrite magnetic material of the present embodiment, residual magnetic flux density Br and coercive force HcJ vary with a specific surface area of finely pulverized material constituting a molded body, but the addition of Al component leads to decrease the variation of coercive force HcJ.

In the ferrite magnetic material of the present embodiment, content of Al component (total amount of each Al component) is 0.2 mass % to 2.5 mass %, preferably 0.55 mass % to 2.45 mass % in terms of Al₂O₃ with respect to 100 mass % of the main component represented by the above composition formula. When the content of Al component is within the above range, high coercive force HcJ is obtained. When the content of Al component is too large, residual magnetic flux density Br of resulting ferrite sintered magnets sometimes decreases.

Cr component to be used is not particularly limited as long as it contains Cr element and may be added as a compound such as Cr₂O₃, Cr₂SiO₃, or Cr₂O₃. nH₂O. Cr component tends to improve coercive force HcJ of the ferrite sintered magnet composed of the ferrite magnetic material of the present embodiment. The addition of Cr component to the ferrite magnetic material leads to favorable sinterability thereof, and to favorable control of magnetic properties due to adequately adjusting a crystal particle size of sintered body. As a result, residual magnetic flux density Br can be favorably maintained while obtaining a high coercive force HcJ.

In the ferrite magnetic material of the present embodiment, a value obtained by dividing the content of Cr component by four is 0.2 mass % to 2.5 mass %, preferably 0.55 mass % to 2.45 mass % with respect to 100 mass % of the main component. It is noted that the content of Cr component is a total of each Cr component used and is a value calculated in terms of Cr₂O₃. When the value relating to the content of Cr component is within the above range, high coercive force HcJ is obtained. When the value is too small, it is difficult to obtain sufficient effects due to adding Cr component. On the other hand, the value is too large, residual magnetic flux density Br of the ferrite sintered magnet sometimes decreases.

When both Al component and Cr component are included, in order to enhance the effect of favorable coercive force HcJ, it is preferred that a sum of Al content in terms of Al₂O₃ and the value obtained by dividing Cr content in terms of Cr₂O₃ by four is 0.2 mass % to 2.5 mass %, particularly from 0.55 mass % to 2.45 mass % with respect to the whole ferrite magnetic material. In order to obtain a favorable residual magnetic flux density Br, a sum of Al content in terms of Al₂O₃ and Cr content in terms of Cr₂O₃ is preferably 2.5 mass % or less because these components sometimes decrease residual magnetic flux density Br of the ferrite sintered magnet.

The ferrite magnetic material of the present embodiment may include a component other than Si, Al and Cr components as a sub component. B (boron) component is exemplified as the other sub component and may be included as a compound such as B₂O₃. The addition of B component makes it possible to lower calcination temperature or sintering temperature upon calcinating raw material compositions to form calcined substances or firing molded products to form sintered bodies. Thus, the ferrite sintered magnet can be produced with good productivity. The content of B component in terms of B₂O₃ is preferably 0.5 mass % or less with respect to the whole ferrite magnetic material because excessive amount of B component tends to decrease saturation magnetization of the ferrite sintered magnet.

Further, as the sub component, the ferrite magnetic material of the present embodiment may include at least one component selected from the group of Ga, Mg, Cu, Mn, Ni, Zn, In, Li, Ti, Zr, Ge, Sn, V, Nb, Ta, Sb, As, W and Mo as oxides. The content of each component in terms of oxide having stoichiometric composition is preferably as follows:

gallium oxide 5 mass % or less, magnesium oxide 5 mass % or less, copper oxide 5 mass % or less, manganese oxide 5 mass % or less, nickel oxide 5 mass % or less, zinc oxide 5 mass % or less, indium oxide 3 mass % or less, lithium oxide 1 mass % or less, titanium oxide 3 mass % or less, zirconium oxide 3 mass % or less, germanium oxide 3 mass % or less, tin oxide 3 mass % or less, vanacium oxide 3 mass % or less, niobium oxide 3 mass % or less, tantalum oxide 3 mass % or less, antimony oxide 3 mass % or less, arsenic oxide 3 mass % or less, tungsten oxide 3 mass % or less, and molybdenum oxide 3 mass % or less.
When the ferrite magnetic material includes a plurality of components selected from said group, the total content is preferably 5 mass % or less to avoid impairing magnetic properties.

The ferrite magnetic materials of the present embodiment including the above main and sub components can be analyzed by, for example, X-ray florescence analysis method. Similarly, the sintered body composed of the ferrite magnetic material can also be analyzed by X-ray florescent analysis method. A content of each element constituting the ferrite magnetic material is determined based on analytical values by this analysis method. As for the existence of the M-type ferrite phase in the ferrite magnetic material, it is possible to identify the existence through observation of diffraction pattern obtained by X-ray diffraction method or electron diffraction method.

In the present embodiment, a specified value is calculated using the formula [(R+A)−(Fe+Co)/12]/Si,

wherein, R, A, Fe and Co mean atom % of each element R, A, Fe and Co in the composition with the formula RₓA₁₋ₓ(Fe_{12-y}Co_{y})_{z} included in the main component, and Si means atom % of Si contained as a sub component. This value is defined as G. This value represents an abundance ratio of components considered to be in the grain boundary due to overflowing from the main phase to Si component.

The value calculated using [(R+A)−(Fe+Co)/12]/Si, i.e. G is preferably 0.3 to 2.3, more preferably 0.4 to 2.0. When G is within the above range, the ferrite magnetic material can favorably maintain a structure of the M-type ferrite even though it has a composition far away from a stoichiometric ratio such as a composition with a large number of A site element and a small number of B site element. As a result, residual magnetic flux density Br is maintained while obtaining a high coercive force HcJ.

In the present embodiment, L (mass %) is defined as a total of content (mass %) of Al component in terms of Al₂O₃ and a value obtained by dividing content (mass %) of Cr component in terms of Cr₂O₃ by four. It is important that the values of L and G are within a specified region shown in x-y coordinate when said L and said G are represented as x-axis and y-axis, respectively. It is noted that the reason why Cr content is divided by four is that Cr component is needed four times compared with Al component to obtain the same effect on improving coercive force HcJ as that of Al component.

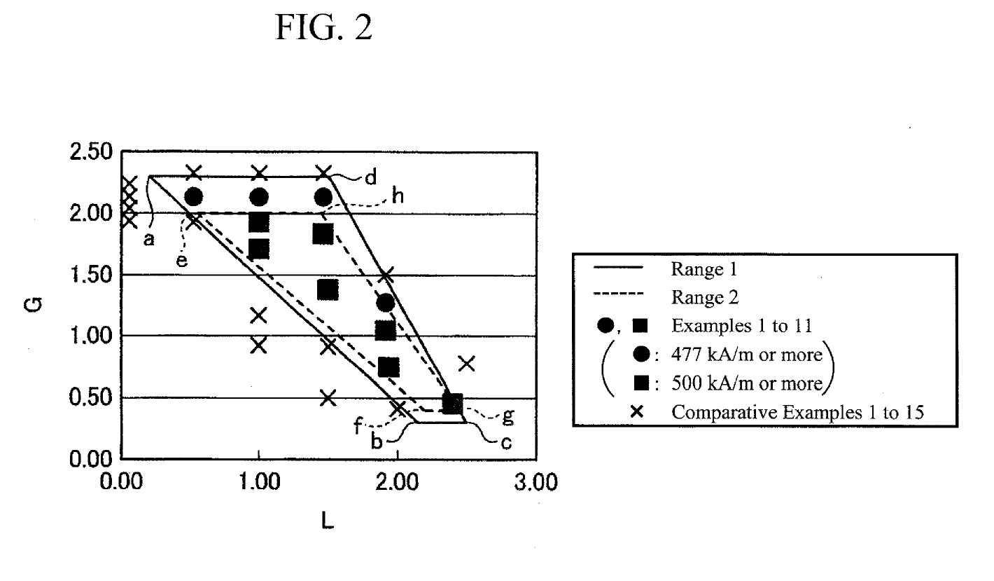

That is, it is necessary that the values of L and G are within the region surrounded by four points shown as a: (0.20, 2.30), b: (2.15, 0.30), c: (2.50, 0.30) and d: (1.50, 2.30) in FIG. 2. The values of L and G are preferably within the region surrounded by four points shown as e: (0.55, 2.00), f: (2.20, 0.40), g: (2.45, 0.40) and h: (1.45, 2.00) in FIG. 2.

It is noted that the term “values within the region surrounded by the four points of a, b, c and d or e, f, g and h” means to include values plotted on the straight lines connecting each point.

When a point determined by a certain value of L and a certain value of G is on or above the straight line connecting points a and b, the ferrite sintered magnet obtained by sintering the ferrite magnetic materials of the present embodiment is capable of having a high coercive force HcJ such as 477 kA/m or more. When the point is on or above the straight line connecting points b and c, Si component favorably functions to control firing of the ferrite magnetic material so that the resulting ferrite sintered magnet can have improved coercive force HcJ. When the point is on or below the straight line connecting points c and d, the resulting ferrite sintered magnet is capable of having a high coercive force Ha such as 477 kA/m or more and a high residual magnetic flux density Br such as 330 mT or more. When the point is on or below the straight line connecting points a and d, the resulting ferrite sintered magnet is capable of having a high coercive force HcJ such as 477 kA/m or more.

In this way, the ferrite magnetic material of the present embodiment requires to adjust a relation between the content (mass %) of Al and/or Cr component, i.e. L and the value calculated using the formula [(R+A)−(Fe+Co)/12]/Si, i.e. G so that a point determined by a certain value of L and a certain value of G falls within the specified region. When the ferrite magnetic material has compositions satisfying the above condition, the resulting ferrite sintered magnet is capable of having further enhanced coercive force HcJ. The ferrite sintered magnet of the present embodiment is capable of having a high coercive force HcJ such as 477 kA/m or more and a high residual magnetic flux density Br such as 330 mT or more. Then, excellent magnetic properties can be obtained. Thus, the ferrite magnetic material of the present embodiment enables to provide the ferrite sintered magnet having high magnetic properties.

Patent Literature 1 discloses that ferrite magnet materials with a high coercive force HcJ such as 494 kA/m are obtained while maintaining a residual magnetic flux density Br by the method containing a step of first pulverization for making powders, a step of heat-treatment for heat-treating the resulting powders and a step of secondary pulverization for making further fine powders. However, performing the heat treatment and the secondary fine pulverization causes increase and complication of manufacturing steps and makes production cost higher. Thus, such a process containing the heat treatment and the secondary fine pulverization is not practical considering a demand that ferrite magnetic materials should be obtained cheaply to be used widely. Also, the manufacturing method disclosed in Patent Literature 1 needs the process with increased steps, such as performing the heat treatment for the powder obtained by the primary fine pulverization and further performing the secondary fine pulverization, to obtain the ferrite magnet having a coercive force HcJ of such as 477 kA/m. On the other hand, unlike Patent Literature 1, there is no need to perform the secondary fine pulverization with the heat treatment after the primary fine pulverization, and then there is no need to increase steps in the manufacture of the ferrite sintered magnet with the ferrite magnetic material of the present embodiment. Thus, the ferrite sintered magnet can be manufactured with low costs using the ferrite magnetic material of the present embodiment. Therefore, the ferrite sintered material of the present embodiment enables to form the ferrite sintered magnets being in excellent in cost performance while having a high coercive force HcJ and maintaining a sufficient residual magnetic flux density Br.

It is preferred that the ferrite magnetic material of the present embodiment does not include an alkaline metal element such as Na, K, or Rb, etc. as a sub component. The alkaline metal element tends to decrease saturation magnetization of ferrite sintered magnet. But, the alkaline metal element may be included in the ferrite magnetic material as long as it is inevitably included in raw materials for the ferrite magnetic material. A content of the alkaline metal element which does not greatly affect magnetic properties is 3 mass % or less.

The ferrite magnetic material of the present embodiment can constitute a ferrite sintered magnet or ferrite magnet powder. Also, the ferrite magnet material of the present embodiment can constitute membranous magnetic layers for magnetic recording medium and the like.

### <Ferrite Sintered Magnet>

Next, a ferrite sintered magnet composed of the ferrite magnetic material of the present embodiment will be explained. The ferrite sintered magnet according to the present embodiment (hereinafter, referred to as the ferrite sintered magnet of the present embodiment) is composed of the ferrite magnetic material of the present embodiment. Thus, the ferrite sintered magnet of the present embodiment can have a high coercive force HcJ while maintaining a high residual magnetic flux density Br, and have good magnetic properties. Also, the ferrite sintered magnet is available at a low price because it can be manufactured at a low cost. The ferrite sintered magnet is not particularly limited relative to a shape thereof and can have various shapes such as flat plate or column.

The ferrite sintered magnet of the present embodiment is composed of the ferrite magnetic material of the present embodiment and includes a crystal particle constituting a main phase and a grain boundary. An average size of the crystal particle of the ferrite sintered magnet is preferably 1.5 μm or less, more preferably 1.0 μm or less, and further more preferably 0.5 μm to 1.0 μm. Such an average crystal particle size makes it easy to obtain a high coercive force HcJ. The average crystal particle size of the sintered body can be determined based on values measured by scanning electron microscope (SEM). Specifically, the crystal particle size is determined as a maximum value among diameters which pass a gravity center of each crystal particle wherein the diameters are obtained by image analysis after recognizing each crystal particle based on photos taken by SEM. The average crystal particle size is determined as a mean value relative to whole measured particles which are about 100 crystal particles per one sample.

Since the ferrite sintered magnet of the present embodiment has the properties set forth above, it can be preferably used as a permanent magnet for various products such as motor, generator, speaker or microphone, magnetron tube, magnetic field generating device for MRI (Magnetic Resonance Imaging system), ABS (Anti-lock Braking System) sensor, fuel or oil level sensor, sensor for distributor and magnet clutch.

Besides the ferrite sintered magnet, the ferrite magnetic material of the present embodiment can constitute a ferrite magnetic powder which is capable of constituting a bonded magnet by being mixed with resin.

### <Method for Manufacturing Ferrite Sintered Magnet>

Next, a method for manufacturing the ferrite sintered magnet of the present embodiment will be explained. Hereinafter, an example of the method for manufacturing the ferrite sintered magnet using the ferrite magnetic material of the present embodiment will be shown.

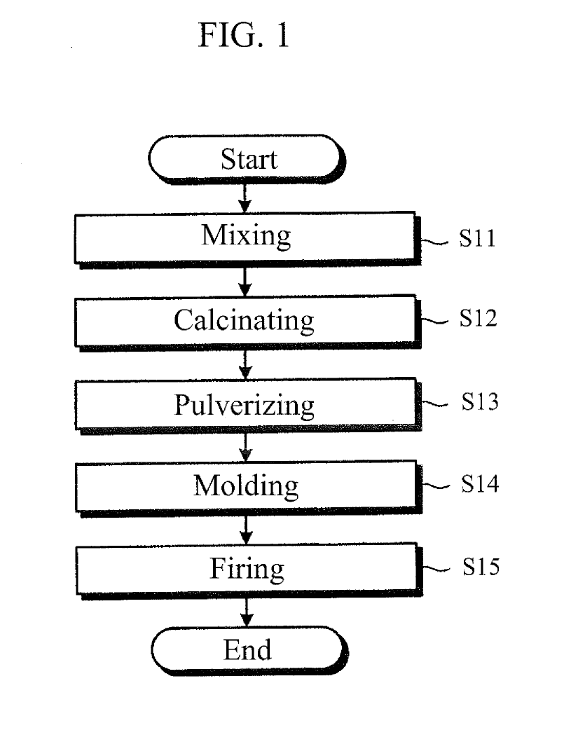

FIG. 1 is a flow chart showing procedures for manufacturing the ferrite sintered magnet of the present embodiment. As shown in FIG. 1, the ferrite sintered magnet can be manufactured through mixing step (step S11), calcinating step (step S12), pulverizing step (step S13), molding step (step S14), and firing step (step S15). Each step will be described hereinafter.

### (Mixing Step: Step S11)

Powdery raw materials of the ferrite magnetic material are weighed so as to satisfy a predetermined proportion, and then mixed while being pulverized for approximately 0.1 to 20 hours using a wet attritor, ball mill or the like to prepare a raw material composition (step S11). As the raw material, there may be used compound containing one or more of elements such as Sr, Ca, La, Fe and Co constituting a ferrite phase. The raw material compounds are preferably powdery. There are exemplified SrCO₃, La(OH)₃, Fe₂O₃, BaCO₃, CaCO₃ and Co₃O₄ etc. as the compound including one of the elements constituting the ferrite phase. As such a compound, there are used, for example, oxides or compounds to be converted thereto by sintering such as carbonates, hydroxides and nitrates. An average particle size of the raw material is not particularly limited and is preferably about 0.1 μm to about 2.0 μm.

Al₂O₃ is exemplified as a raw material of Al component in the ferrite magnetic material of the present embodiment, but the raw material of Al component is not particularly limited as long as it is a compound including Al. The raw material of Al component may include a raw material of other sub components in a form of single element, oxide or the like if needed.

SiO₂ is exemplified as a raw material of Si component in the ferrite magnetic material of the present embodiment, but the raw material of Si component is not particularly limited as long as it is a compound including Si. The raw material of Si component may include a raw material of other sub components in a form of single element, oxide or the like if needed.

It is not necessary to mix all of the raw materials in the mixing step, and a part or all of each of the raw materials may be added after the calcinating step mentioned hereinafter. For example, it is allowable to add raw materials of Al and Si used as a sub component such as Al₂O₃ and SiO₂ or raw materials of Ca constituting a main component such as CaCo₃ during the pulverizing step mentioned hereinafter, especially finely pulverizing step, which is carried out after the calcinating step. The timing of the addition may be adjusted so that a desired composition and magnetic properties are easily obtained.

### (Calcinating Step: Step S12)

The raw material composition obtained in the mixing step (STEP S11) is dried, sized, and then calcined to form a granular calcined substance (STEP S12). The calcination is preferably carried out in oxidative atmosphere such as in air at a calcination temperature within a range of 1100° C. to 1400° C., more preferably 1100° C. to 1300° C., and further more preferably 1100° C. to 1250° C. The time of the calcination is preferably 1 second to 10 hours and more preferably 1 hour to 3 hours. The calcined substance obtained by the calcination includes the aforesaid main phase in a range of 70% or more whose primary particle size is preferably 10 μm or less and more preferably 2 μm or less.

In the calcinating step (STEP S12), a ferrite having a hexagonal crystal structure is formed as the main component by calcining the raw material composition, and thereby the ferrite magnetic material of the present embodiment is manufactured.

### (Pulverizing Step: Step S13)

The granular calcined substance obtained in the calcinating step (step S12) is pulverized to form a calcined powder (step S13). This operation makes it easy to perform molding of the ferrite magnetic material in the molding step mentioned herein after (step S14). Raw materials not mixed in the mixing step may be added during the pulverizating step, and this operation is referred to as post addition of raw materials. The pulverizing step may be carried out in a two-step process which has a coarsely pulverizing step for forming a coarse pulverized powder and a finely pulverizing step carried out subsequently for forming a fine powder.

In the coarsely pulverizing step, the granular calcined substance is pulverized by using a vibration mill etc. to have an average particle size of 0.5 μm to 5.0 μm. The resulting powder is referred to as “coarsely pulverized powder”. In the finely pulverizing step, the coarsely pulverized powder is mixed with water and sorbitol to form slurry used for further pulverization. Then, the resulting slurry is subjected to pulverize the coarsely pulverized powder therein in wet condition by using a ball mill. A means of the fine pulverization is not limited to the ball mill, and there can be used wet attritor, vibration mill, ball mill, jet mill etc. The powder obtained by the fine pulverization is referred to as “finely pulverized material”. The fine pulverization is performed so that the finely pulverized powder has an average particle size of preferably about 0.08 μm to about 2.0 μm, more preferably about 0.1 μm to about 1.0 μm, and further more preferably about 0.2 μm to 0.8 μm. A specific surface area of the finely pulverized material is preferably about 7 m²/g to about 12 m²/g. Preferable time for the pulverization is appropriately selected according to the pulverizing method to be used. For instance, about 30 minutes to about 10 hours are preferable for the wet attritor and about 10 hours to about 50 hours are preferable for the wet pulverization with the ball mill. Note that, the specific surface area of the finely pulverized material is obtained such as by BET method.

When adding a part of the raw materials during the pulverizing step, for example, the addition is preferably performed during the fine pulverization. In the present embodiment, Al₂O₃, SiO₂ and CaCO₃ may be added as a raw material of Al component, Si component or Ca component, respectively.

In the finely pulverizing step, in order to increase degree of magnetic orientation of the sintered body obtained after firing, surfactant such as polyhydric alcohol represented by the formula of Cₙ(OH)ₙHₙ₊₂ is preferably added to the slurry for pulverization. As for the polyhydric alcohol, n in the formula is preferably 4 to 100, more preferably 4 to 30, further more preferably 4 to 20, and particularly preferably 4 to 12. Sorbitol is exemplified as the polyhydric alcohol. Further, polyhydric alcohol of two or more kinds can be used together. Also, the polyhydric alcohol may be used with other known dispersants.

When the polyhydric alcohol is added, the addition amount is preferably 0.05 mass % to 5.0 mass %, more preferably 0.1 mass % to 3.0 mass %, and further more preferably 0.2 mass % to 2.0 mass % with respect to an object to be added such as coarsely pulverized materials. Polyhydric alcohol added in the finely pulverizing step is removed by heat decomposition during the firing step described hereinafter (step S15).

### (Molding Step: Step S14)

The pulverized material obtained in the pulverizing step (step S13), preferably finely pulverized material, is molded in a magnetic field to form a molded product (MOLDING STEP: STEP S14). The molding may be performed by dry molding or wet molding. In view of increasing degree of magnetic orientation, the molding is preferably performed by the wet molding.

In the ease of the wet molding method, for example, it is preferred that shiny is prepared by the fine pulverization carried out in wet condition in the pulverizing step (step S13), the slurry being concentrated to a predetermined concentration suitable for wet molding, and then the slurry being provided for wet molding. Such concentration of the slurry can be carried out with a centrifugal separator, filter press or the like. The finely pulverized material preferably accounts for about 30 mass % to 80 mass % of the slurry. Water is preferably used as a dispersion medium to disperse the finely pulverized material in the slurry, and may be added to the slurry with surfactant such as gluconic acid, gluconate and sorbitol. Also, non-aqueous solvents may be used as a dispersion medium. An organic solvent such as toluene or xylene may be used as the non-aqueous solvent. When the non-aqueous solvent is used, it is preferred to add surfactant such as oleic acid. It is noted that the slurry for wet molding may be prepared by adding a dispersion medium or the like to the finely pulverized material dried after the fine pulverization.

In the case of the wet molding, the slurry is molded in a magnetic field. The molding pressure is preferably about 9.8 MPa to 49 MPa (0.1 ton/cm² to 0.5 ton/cm²), and the applied magnetic field is preferably about 398 kA/m to 1194 kA/m (5 kOe to 15 kOe).

### (Firing Step: Step S15)

The molded body thus obtained in the molding step (STEP S14) is fired to yield a sintered body (FIRING STEP: STEP15). Thus, the ferrite sintered magnet of the present embodiment can be obtained by sintering the ferrite magnetic material of the present embodiment.

The firing can be performed in oxidative atmosphere such as in air. The firing temperature is preferably about 1050° C. to about 1270° C. and more preferably about 1080° C. to about 1240° C. The firing time during which the temperature is retained at the firing temperature is preferably set to be about 0.5 hours to about 3 hours.

When the molded body is obtained by the wet molding, if it is rapidly heated for the firing without sufficient drying thereof, there is a possibility that cracking occurs due to a drastic volatilization of dispersion medium or so. Thus, it is preferred to suppress the incidence of cracking on the surface of the sintered body by sufficiently drying the molded body before reaching the above firing temperature. For example, the temperature is increased from room temperature to about 100° C. at a temperature increase rate of about 0.5° C./min. Further, when a surfactant (dispersant) or the like is added, it is preferred to sufficiently remove the surfactant or so by carrying out degreasing treatment that is performed by heating at a temperature increase rate of about 2.5° C./min within a temperature range of about 100° C. to about 500° C. These treatments may be performed at the beginning of the firing step or may be separately performed prior to the firing step.

The aforesaid explanation is an example of a preferable method for manufacturing the ferrite sintered magnet of the present embodiment. The manufacturing method is not limited to the above as long as the ferrite magnetic material of the present embodiment is used. The conditions thereof may be appropriately changed.

In the case of manufacturing a bond magnet, but not a sintered magnet, the bond magnet including the powder of the ferrite magnetic material can be obtained by, for example, carrying out the pulverizing step, mixing the resulting pulverized material with a binder to make a composition, and then molding the resulting composition in a magnetic field.

### EXAMPLES

Hereinafter, the present invention will be explained more specifically with reference to Examples and Comparative Examples. However, the present invention is not limited to the following Examples.

### 1. Manufacture of Ferrite Sintered Magnet

### Examples 1 to 11, Comparative Examples 1 to 15

First, as raw materials for a main component of a ferrite magnetic material, lanthanum hydroxide (La(OH)₃), calcium carbonate (CaCO₃), strontium carbonate (SrCO₃), iron oxide (Fe₂O₃), and cobalt oxide (Co₃O₄) were prepared. These raw materials were weighed so as to have composition ratios shown in Table 1 with respect to the main component. These raw materials were weighed so as to have atomic ratios represented by the following composition formula exclusive of oxygen with respect to the main phase which is obtained after firing. Note that, indications inside the brackets in Table 1 show composition ratios of the following composition formula.

RₓA₁₋ₓ(Fe_{12-y}Co_{y})_{z} Composition Formula:

TABLE 1

| | | | | | | | | | Al₂O₃ | |
|---|---|---|---|---|---|---|---|---|---|---|
| | La | | | | | Fe | Co | La/Co | [L] | SiO₂ |
| Sample | [x] | Ca | Sr | [1 − x] | 12z | [(12 − y)z] | [yz] | x/yz | (mass %) | (mass %) |
| C | 0.50 | 0.35 | 0.15 | 0.50 | 11.60 | 11.45 | 0.15 | 3.33 | 0.06 | 0.31 |

Next, the raw materials thus-prepared were mixed and pulverized by a wet attritor to yield a slurry-like raw material composition (Mixing Step). The resultant slurry was dried, subsequently calcined in air at 1200° C. for 1.0 hour (Calcining Step). The resultant calcined powders were pulverized by a vibration rod mill to obtain coarsely pulverized materials. Iron oxide (Fe₂O₃), strontium carbonate (SrCO₃), calcium carbonate (CaCO₃), and cobalt oxide (CO₃O₄) were respectively added to the resultant coarsely pulverized material so as to have atomic ratios shown in Table 2. Silicon oxide (SiO₂) and aluminum oxide (Al₂O₃) were also added to the coarsely-pulverized material to have mass % shown in Table 2. The mixture thus-obtained was finely pulverized in a solvent composed of water and sorbitol by a wet ball mill for 30 hours (Pulverizing Step), Next, the resultant slurry was dehydrated so that solid content thereof becomes suitable for wet molding. Molding of the slurry was carried out using a wet magnetic field molding machine in an applied magnetic field of about 1000 kA/m (12 kOe) to form a columnar molded body having 30 mm of diameter and 15 mm of thickness (Molding Step). The obtained columnar molded body was sufficiently dried at room temperature in air and held for firing at 1200° C. for 1 hour in air. Thus, the ferrite sintered magnet was obtained (Firing Step). Each of the obtained ferrite sintered magnets was named as sample C1 to C26.

### Examples 12 to 65 and Comparative Examples 16 to 27

Coarsely pulverized materials were obtained according to the same method as EXAMPLES 1 to 11 and COMPARATIVE EXAMPLES 1 to 15 except for varying the composition of the main component. Subsequently, ferrite sintered magnets were obtained according to the same method except for adding to the obtained coarsely pulverized material iron oxide (Fe₂O₃), strontium carbonate (SrCO₃), calcium carbonate (CaCO₃), and cobalt oxide (CO₃O₄) so as to have atomic ratios shown in Table 3, and silicon oxide (SiO₂) and aluminum oxide (Al₂O₃) so as to have mass % shown in Table 3. Ferrite sintered magnets shown in Table 4 were obtained by changing aluminum oxide (Al₂O₃) to chromium oxide (Cr₂O₃). Ferrite sintered magnets shown in Table 5 were obtained by changing aluminum oxide (Al₂O₃) to a mixture of aluminum oxide (Al₂O₃) and chromium oxide (Cr₂O₃). Ferrite sintered magnets shown in Table 6 were obtained by replacing a part of Sr used in Examples 19, 29, and 39 with Ba. Ferrite sintered magnets shown in Table 7 were obtained by varying amounts of Al and Si in the composition of C16. Each of the obtained ferrite sintered magnets was named as samples D1 to D66.

### 2. Evaluation

### (Composition of Sintered Body)

The composition (La, Ca, Sr, Fe, Co, Al, and Si) of the obtained sintered body was measured by X-ray fluorescence quantitative analysis. Also, content of each element was calculated based on a sum of all elements constituting the main component (La, Ca, Sr, Fe, and Co) and the sub component (Al and Si).

### (Evaluation of Ferrite Sintered Magnet)

Top and bottom surfaces of the obtained columnar molded bodies (C1 to C26 and D1 to D66) were processed. Subsequently, residual magnetic flux density Br and coercive force HcJ were measured at room temperature (25° C.) using B-H tracer having about 2000 kA/m (25 kOe) of maximum applied magnetic field.

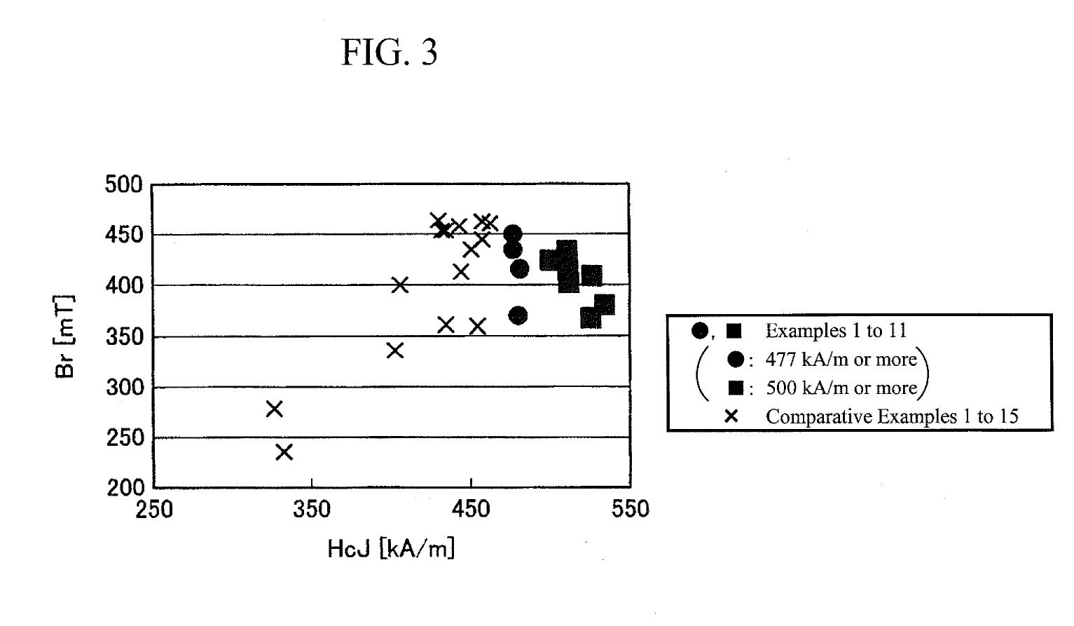

With respect to samples C1 to C26, Table 2 shows results of composition ratio of the main component, Al content, Si content, molar ratio (i.e. G), residual magnetic flux density Br and coercive force HcJ. L is either Al content of Al component in terms of Al₂O₃, a value obtained by dividing Cr content amount of Cr component in terms of Cr₂O₃ by four or sum thereof. G is a value in atom % obtained by calculating [(R+A)−(Fe+Co)/12]/Si where R, A, Fe, Co and Si indicate values of each atom % thereof. FIG. 2 shows the relation between L and G placed on (x, y) coordinated where L and G are shown on x-axis and y-axis, respectively. FIG. 3 shows the relation between the measured coercive force HcJ and the measured residual magnetic flux density Br. In FIG. 2, points within the region surrounded by straight lines connecting four points of a: (0.20, 2.30), b: (2.15, 0.30), c: (2.50, 0.30), and d: (1.50, 2.30) which is named as Range 1 were plotted with marks of black square or black circle (Examples 1 to 11), and the other points outside Range 1 were plotted with marks of ×(Comparative Examples 1 to 15). Note that, points plotted with marks of black circle show that coercive force HcJ is 477 kA/m or more and less than 500 kA/m, and points plotted with marks of black square show that coercive force HcJ is 500 kA/m or more. In FIG. 2, Range 2 is defined to be the region surrounded by straight lines connecting four points of e: (0.55, 2.00), f: (2.20, 0.40), g: (2.45, 0.40), and h: (1.45, 2.00), which include the points plotted with marks of black square.

TABLE 2

| | | | | | | | | | | | Al₂O₃ | | | Magnetic Property | |
|---|---|---|---|---|---|---|---|---|---|---|---|---|---|---|---|
| | | | La | | | | | Fe | Co | La/Co | [L] | SiO₂ | | Br | HcJ |
| | | Sample | [x] | Ca | Sr | [1 − x] | 12z | [(12 − y)z] | [yz] | x/yz | (mass %) | (mass %) | G | (mT) | (kA/m) |
| Comparative | 1 | C1 | 0.39 | 0.46 | 0.15 | 0.61 | 9.29 | 9.04 | 0.25 | 1.56 | 0.06 | 0.70 | 2.24 | 463.6 | 430.4 |
| Example | | | | | | | | | | | | | | | |
| Comparative | 2 | C2 | 0.39 | 0.46 | 0.15 | 0.61 | 9.29 | 9.04 | 0.25 | 1.56 | 0.06 | 0.74 | 2.14 | 462.6 | 458.1 |
| Example | | | | | | | | | | | | | | | |
| Comparative | 3 | C3 | 0.39 | 0.46 | 0.15 | 0.61 | 9.29 | 9.04 | 0.25 | 1.56 | 0.06 | 0.79 | 2.04 | 460.9 | 462.8 |
| Example | | | | | | | | | | | | | | | |
| Comparative | 4 | C4 | 0.39 | 0.46 | 0.15 | 0.61 | 9.29 | 9.04 | 0.25 | 1.56 | 0.06 | 0.84 | 1.94 | 458.1 | 443.4 |
| Example | | | | | | | | | | | | | | | |
| Comparative | 5 | C5 | 0.39 | 0.46 | 0.15 | 0.61 | 9.29 | 9.04 | 0.25 | 1.56 | 0.53 | 0.66 | 2.33 | 453.3 | 432.4 |
| Example | | | | | | | | | | | | | | | |
| Example | 1 | C6 | 0.39 | 0.46 | 0.15 | 0.61 | 9.29 | 9.04 | 0.25 | 1.56 | 0.53 | 0.74 | 2.13 | 449.5 | 477.1 |
| Comparative | 6 | C7 | 0.39 | 0.46 | 0.15 | 0.61 | 9.29 | 9.04 | 0.25 | 1.56 | 0.53 | 0.84 | 1.93 | 444.4 | 458.0 |
| Example | | | | | | | | | | | | | | | |
| Comparative | 7 | C8 | 0.39 | 0.46 | 0.15 | 0.61 | 9.29 | 9.04 | 0.25 | 1.56 | 1.00 | 0.64 | 2.33 | 434.5 | 451.1 |
| Example | | | | | | | | | | | | | | | |
| Example | 2 | C9 | 0.39 | 0.46 | 0.15 | 0.61 | 9.29 | 9.04 | 0.25 | 1.56 | 1.00 | 0.72 | 2.13 | 434.1 | 477.2 |
| Example | 3 | C10 | 0.39 | 0.46 | 0.15 | 0.61 | 9.29 | 9.04 | 0.25 | 1.56 | 1.00 | 0.80 | 1.93 | 433.4 | 511.0 |
| Example | 4 | C11 | 0.39 | 0.46 | 0.15 | 0.61 | 9.29 | 9.04 | 0.25 | 1.56 | 1.00 | 0.88 | 1.71 | 423.6 | 500.9 |
| Comparative | 8 | C12 | 0.39 | 0.46 | 0.15 | 0.61 | 9.29 | 9.04 | 0.25 | 1.56 | 1.00 | 1.27 | 1.17 | 400.0 | 406.5 |
| Example | | | | | | | | | | | | | | | |
| Comparative | 9 | C13 | 0.39 | 0.46 | 0.15 | 0.61 | 9.29 | 9.04 | 0.25 | 1.56 | 1.00 | 1.68 | 0.92 | 453.2 | 435.2 |
| Example | | | | | | | | | | | | | | | |
| Comparative | 10 | C14 | 0.39 | 0.46 | 0.15 | 0.61 | 9.29 | 9.04 | 0.25 | 1.56 | 1.46 | 0.65 | 2.33 | 412.4 | 444.6 |
| Example | | | | | | | | | | | | | | | |
| Example | 5 | C15 | 0.39 | 0.46 | 0.15 | 0.61 | 9.29 | 9.04 | 0.25 | 1.56 | 1.46 | 0.73 | 2.13 | 415.1 | 481.4 |
| Example | 6 | C16 | 0.39 | 0.46 | 0.15 | 0.61 | 9.29 | 9.04 | 0.25 | 1.56 | 1.46 | 0.83 | 1.84 | 413.9 | 511.8 |
| Example | 7 | C17 | 0.39 | 0.46 | 0.15 | 0.61 | 9.29 | 9.04 | 0.25 | 1.56 | 1.50 | 1.15 | 1.38 | 408.3 | 526.4 |
| Comparative | 11 | C18 | 0.39 | 0.46 | 0.15 | 0.61 | 9.29 | 9.04 | 0.25 | 1.56 | 1.50 | 1.65 | 0.92 | 360.9 | 435.0 |
| Example | | | | | | | | | | | | | | | |
| Comparative | 12 | C19 | 0.39 | 0.46 | 0.15 | 0.61 | 9.29 | 9.04 | 0.25 | 1.56 | 1.50 | 2.90 | 0.50 | 277.9 | 326.6 |
| Example | | | | | | | | | | | | | | | |
| Comparative | 13 | C20 | 0.39 | 0.46 | 0.15 | 0.61 | 9.29 | 9.04 | 0.25 | 1.56 | 1.92 | 1.12 | 1.51 | 359.1 | 454.6 |
| Example | | | | | | | | | | | | | | | |
| Example | 8 | C21 | 0.39 | 0.46 | 0.15 | 0.61 | 9.29 | 9.04 | 0.25 | 1.56 | 1.92 | 1.21 | 1.28 | 369.9 | 480.2 |
| Example | 9 | C22 | 0.39 | 0.46 | 0.15 | 0.61 | 9.29 | 9.04 | 0.25 | 1.56 | 1.92 | 1.49 | 1.05 | 379.8 | 534.4 |
| Example | 10 | C23 | 0.39 | 0.46 | 0.15 | 0.61 | 9.29 | 9.04 | 0.25 | 1.56 | 1.94 | 1.80 | 0.75 | 366.8 | 525.8 |
| Comparative | 14 | C24 | 0.39 | 0.46 | 0.15 | 0.61 | 9.29 | 9.04 | 0.25 | 1.56 | 2.00 | 3.70 | 0.41 | 235.0 | 332.6 |
| Example | | | | | | | | | | | | | | | |
| Example | 11 | C25 | 0.39 | 0.46 | 0.15 | 0.61 | 9.29 | 9.04 | 0.25 | 1.56 | 2.40 | 3.60 | 0.46 | 401.7 | 512.1 |
| Comparative | 15 | C26 | 0.39 | 0.46 | 0.15 | 0.61 | 9.29 | 9.04 | 0.25 | 1.56 | 2.50 | 1.75 | 0.78 | 335.5 | 402.8 |
| Example | | | | | | | | | | | | | | | |

As shown in Table 2, FIGS. 2 and 3, the ferrite sintered magnets whose L and G are values within the region surrounded by the straight lines connecting the four points of a, b, c, and din FIG. 2 had a residual magnetic flux density Br of 330 mT or more and a coercive force HcJ of 477 kA/m or more. The ferrite sintered magnets whose L and G are values within the region surrounded by the straight lines connecting the four points of e, f, g, and h in FIG. 2 had a coercive force HcJ of 500 kA/m or more. As shown in FIG. 2, it turned out that coercive force HcJ of the ferrite sintered magnets was decreased unless G was within the range of the predetermined value even if L was increased. From this, it turned out that coercive force HcJ of the ferrite sintered magnets cannot be improved if values of both L and G are not selected properly. Thus, it can be said that, in the manufacture of the ferrite sintered magnets, not only increasing Al content but also making values of [(R+A)−(Fe+Co)/12]/Si in the range of the predetermined values is necessary to further improve coercive force HcJ of the ferrite sintered magnet. Therefore, it turned out that coercive force HcJ of the ferrite sintered magnets can be further improved by adjusting the relation between Al content and the values of [(R+A)−(Fe+Co)/12]/Si.

Table 3 shows results of composition ratios of the main components, Al content amount, Si content amount, mole ratios, residual magnetic flux density Br, and coercive force HcJ of the respective samples D1 to D38. Tables 4 to 7 show a relation between x, 12z, x/yz, Ca/Sr and a measured coercive force HcJ.

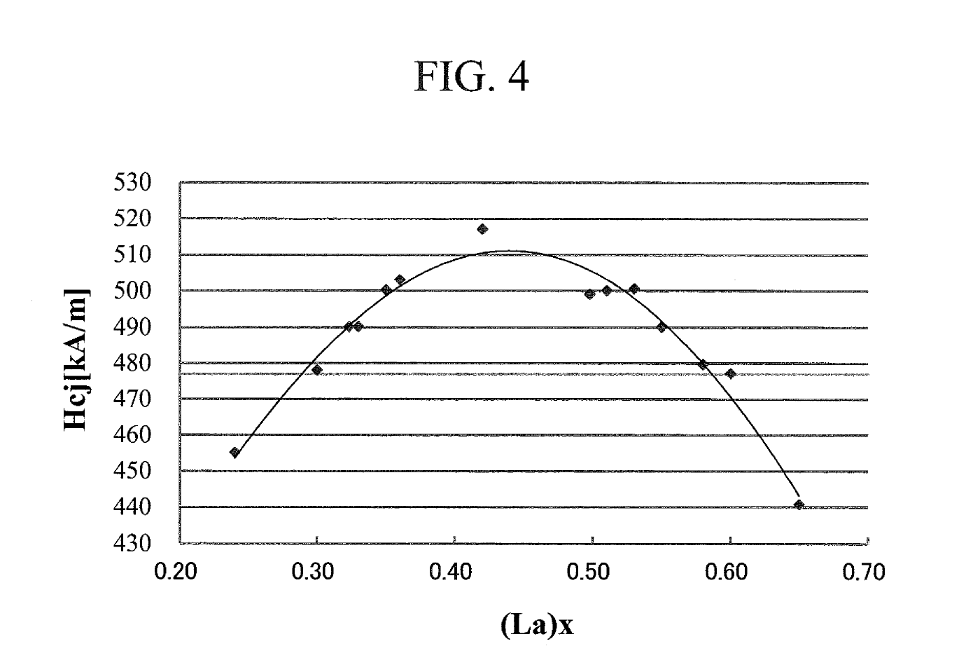

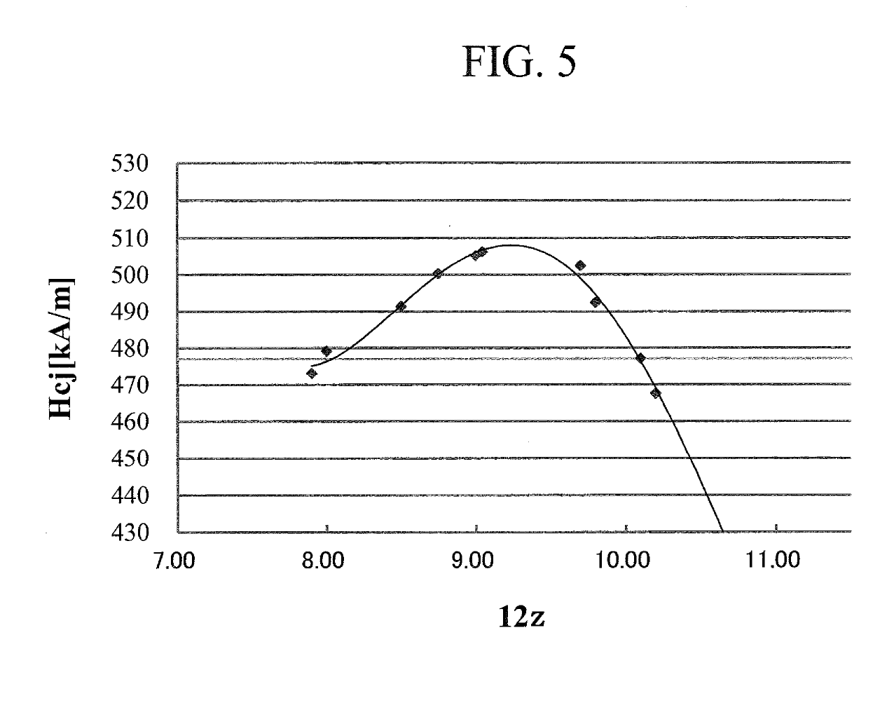

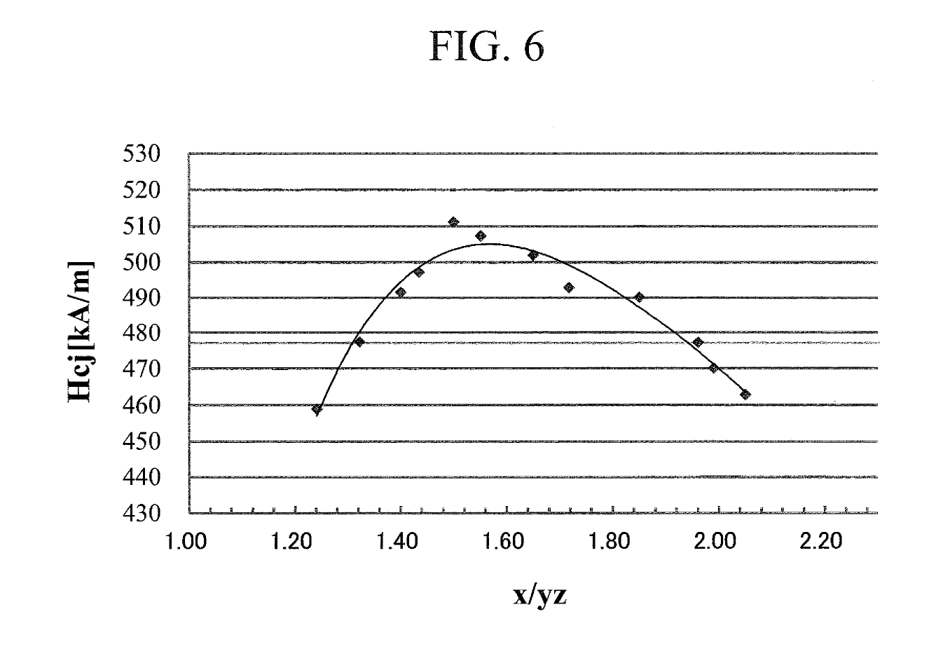

As shown in Table 3 and FIGS. 4 to 6, ferrite sintered magnets satisfying all of 0.3≦x≦0.6, 8.0≦12z≦10.1, and 1.32≦x/yz≦1.96 had residual magnetic flux density Br of 330 mT or more and coercive force HcJ of 477 kA/m or more.

As shown in the data of D1 to D38, when the composition ratios of the main components satisfy the most preferable condition shown as 0.35≦x≦0.53, 8.75≦12z≦9.7 and 1.5≦x/yz≦1.65, and L and G have values within the Range 2, residual magnetic flux density Br of 366 mT or more and coercive force HcJ of 500 kA/m or more were obtained as with C1 to C26.

TABLE 3

| | | | | | | | | | | | Al₂O₃ | | | Magnetic Property | |
|---|---|---|---|---|---|---|---|---|---|---|---|---|---|---|---|
| | | | La | | | | | Fe | Co | La/Co | [L] | SiO₂ | | Br | HcJ |
| | | Sample | [x] | Ca | Sr | Ca/Sr | 12z | [(12 − y)z] | [yz] | x/yz | (mass %) | (mass %) | G | (mT) | (kA/m) |
| Comparative | 16 | D1 | 0.24 | 0.60 | 0.16 | 3.8 | 9.47 | 9.29 | 0.18 | 1.34 | 1.87 | 1.04 | 1.39 | 351.2 | 455.0 |
| Example | | | | | | | | | | | | | | | |
| Example | 12 | D2 | 0.30 | 0.55 | 0.15 | 3.7 | 9.50 | 9.27 | 0.23 | 1.32 | 2.21 | 2.00 | 0.73 | 342.0 | 478.0 |
| Example | 13 | D3 | 0.32 | 0.52 | 0.15 | 3.4 | 9.54 | 9.33 | 0.21 | 1.58 | 2.44 | 3.20 | 0.42 | 330.6 | 490.1 |
| Example | 14 | D4 | 0.33 | 0.51 | 0.16 | 3.2 | 9.53 | 9.32 | 0.21 | 1.60 | 1.83 | 1.00 | 1.44 | 350.6 | 490.2 |
| Example | 15 | D5 | 0.35 | 0.49 | 0.16 | 3.1 | 9.52 | 9.30 | 0.22 | 1.56 | 1.35 | 0.98 | 1.48 | 407.0 | 500.2 |
| Example | 16 | D6 | 0.36 | 0.48 | 0.16 | 3.0 | 9.52 | 9.29 | 0.23 | 1.56 | 1.35 | 1.00 | 1.45 | 409.3 | 503.0 |
| Example | 17 | D7 | 0.42 | 0.43 | 0.15 | 2.9 | 9.50 | 9.23 | 0.27 | 1.57 | 1.25 | 0.98 | 1.49 | 412.2 | 517.0 |
| Example | 18 | D8 | 0.50 | 0.35 | 0.15 | 2.4 | 9.51 | 9.22 | 0.30 | 1.69 | 1.33 | 0.76 | 1.81 | 416.0 | 490.2 |
| Example | 19 | D9 | 0.50 | 0.35 | 0.15 | 2.4 | 9.51 | 9.22 | 0.30 | 1.69 | 1.48 | 0.76 | 1.81 | 408.7 | 499.1 |
| Example | 20 | D10 | 0.51 | 0.34 | 0.15 | 2.3 | 9.51 | 9.20 | 0.31 | 1.65 | 1.48 | 0.78 | 1.86 | 409.2 | 500.0 |
| Example | 21 | D11 | 0.53 | 0.32 | 0.15 | 2.4 | 9.51 | 9.22 | 0.33 | 1.61 | 1.48 | 0.75 | 1.91 | 410.9 | 500.6 |
| Example | 22 | D12 | 0.55 | 0.30 | 0.15 | 2.0 | 9.51 | 9.16 | 0.35 | 1.58 | 1.42 | 1.24 | 1.18 | 415.3 | 490.1 |
| Example | 23 | D13 | 0.58 | 0.27 | 0.15 | 1.8 | 9.49 | 9.12 | 0.37 | 1.55 | 1.40 | 1.01 | 1.46 | 408.6 | 479.6 |
| Example | 24 | D14 | 0.60 | 0.25 | 0.15 | 1.7 | 9.51 | 9.12 | 0.39 | 1.52 | 2.02 | 1.26 | 1.16 | 367.1 | 477.1 |
| Comparative | 17 | D15 | 0.65 | 0.21 | 0.14 | 1.5 | 9.51 | 9.09 | 0.42 | 1.55 | 1.34 | 1.25 | 1.18 | 400.0 | 440.8 |
| Example | | | | | | | | | | | | | | | |
| Comparative | 18 | D16 | 0.39 | 0.46 | 0.15 | 3.1 | 7.90 | 7.75 | 0.25 | 1.56 | 1.31 | 1.30 | 2.02 | 401.8 | 473.0 |
| Example | | | | | | | | | | | | | | | |
| Example | 25 | D17 | 0.39 | 0.46 | 0.15 | 3.1 | 8.00 | 7.76 | 0.24 | 1.60 | 1.22 | 1.28 | 1.82 | 410.0 | 479.1 |
| Example | 26 | D18 | 0.39 | 0.46 | 0.15 | 3.1 | 8.50 | 8.25 | 0.25 | 1.55 | 1.20 | 1.10 | 1.86 | 413.3 | 491.3 |
| Example | 27 | D19 | 0.39 | 0.46 | 0.15 | 3.1 | 8.75 | 8.50 | 0.25 | 1.55 | 1.20 | 1.10 | 1.72 | 408.7 | 500.2 |
| Example | 28 | D20 | 0.39 | 0.46 | 0.15 | 3.1 | 9.00 | 8.75 | 0.25 | 1.56 | 1.30 | 1.20 | 1.46 | 420.8 | 505.2 |
| Example | 29 | D21 | 0.39 | 0.48 | 0.15 | 3.0 | 9.04 | 8.79 | 0.25 | 1.55 | 0.91 | 0.89 | 1.97 | 431.2 | 506.2 |
| Example | 30 | D22 | 0.39 | 0.46 | 0.15 | 3.1 | 9.70 | 9.45 | 0.25 | 1.58 | 1.27 | 0.87 | 1.54 | 412.9 | 502.4 |
| Example | 31 | D23 | 0.39 | 0.46 | 0.15 | 3.1 | 9.80 | 9.55 | 0.25 | 1.57 | 1.12 | 0.88 | 1.46 | 396.4 | 492.3 |
| Example | 32 | D24 | 0.39 | 0.46 | 0.15 | 3.1 | 10.1 | 9.85 | 0.25 | 1.59 | 1.23 | 0.85 | 1.31 | 382.8 | 477.1 |
| Comparative | 19 | D25 | 0.39 | 0.46 | 0.15 | 3.0 | 10.2 | 9.91 | 0.25 | 1.57 | 1.68 | 0.59 | 1.67 | 381.6 | 467.6 |
| Example | | | | | | | | | | | | | | | |
| Comparative | 20 | D26 | 0.39 | 0.46 | 0.15 | 3.0 | 11.1 | 10.85 | 0.25 | 1.55 | 0.87 | 0.30 | 1.47 | 413.0 | 390.0 |
| Example | | | | | | | | | | | | | | | |
| Comparative | 21 | D27 | 0.39 | 0.46 | 0.15 | 3.0 | 9.39 | 9.08 | 0.31 | 1.24 | 0.91 | 0.75 | 2.00 | 430.4 | 458.9 |
| Example | | | | | | | | | | | | | | | |
| Example | 33 | D28 | 0.39 | 0.46 | 0.15 | 3.1 | 9.47 | 9.17 | 0.30 | 1.32 | 0.93 | 0.74 | 1.95 | 430.3 | 477.3 |
| Example | 34 | D29 | 0.39 | 0.46 | 0.15 | 3.1 | 9.03 | 8.75 | 0.28 | 1.40 | 1.00 | 0.84 | 2.08 | 431.2 | 491.5 |
| Example | 35 | D30 | 0.39 | 0.46 | 0.15 | 3.1 | 9.43 | 9.16 | 0.27 | 1.43 | 0.95 | 0.75 | 1.97 | 433.2 | 497.1 |
| Example | 36 | D31 | 0.39 | 0.46 | 0.15 | 3.1 | 9.10 | 8.84 | 0.26 | 1.50 | 1.10 | 0.87 | 1.94 | 433.0 | 511.0 |
| Example | 37 | D32 | 0.39 | 0.46 | 0.15 | 3.1 | 9.44 | 9.19 | 0.25 | 1.55 | 0.92 | 0.78 | 1.88 | 432.1 | 507.2 |
| Example | 38 | D33 | 0.39 | 0.46 | 0.15 | 3.1 | 9.02 | 8.78 | 0.24 | 1.65 | 1.20 | 0.90 | 1.93 | 409.9 | 501.9 |
| Example | 39 | D34 | 0.39 | 0.46 | 0.15 | 3.1 | 9.48 | 9.26 | 0.23 | 1.72 | 1.24 | 0.80 | 1.78 | 397.9 | 492.8 |
| Example | 40 | D35 | 0.39 | 0.46 | 0.15 | 3.1 | 9.03 | 8.82 | 0.21 | 1.85 | 1.30 | 0.81 | 2.14 | 380.0 | 490.1 |
| Example | 41 | D36 | 0.39 | 0.46 | 0.15 | 3.1 | 9.04 | 8.84 | 0.20 | 1.96 | 1.40 | 0.82 | 2.11 | 360.4 | 477.1 |
| Comparative | 22 | D37 | 0.61 | 0.25 | 0.14 | 1.8 | 9.26 | 8.95 | 0.30 | 1.99 | 1.63 | 0.77 | 2.01 | 369.7 | 470.0 |
| Example | | | | | | | | | | | | | | | |
| Comparative | 23 | D38 | 0.39 | 0.46 | 0.15 | 3.1 | 9.03 | 8.84 | 0.19 | 2.05 | 1.55 | 0.81 | 2.14 | 367.5 | 462.8 |
| Example | | | | | | | | | | | | | | | |

As shown in Table 4, even if aluminum oxide (Al₂O₃) was changed to chromium oxide (Cr₂O₃), the ferrite sintered magnets of D40 to D45 satisfying all constituent features of the present invention had a residual magnetic flux density Br of 374 mT or more and a coercive force HcJ of 478 kA/m or more.

TABLE 4

| | | | | | | | | | | | Cr₂O₃/4 | | | Magnetic Property | |
|---|---|---|---|---|---|---|---|---|---|---|---|---|---|---|---|
| | | | La | | | | | Fe | Co | La/Co | [L] | SiO₂ | | Br | HcJ |
| | | Sample | [x] | Ca | Sr | Ca/Sr | 12z | [(12 − y)z] | [yz] | x/yz | (mass %) | (mass %) | G | (mT) | (kA/m) |
| Comparative | 24 | D39 | 0.39 | 0.46 | 0.15 | 3.1 | 9.29 | 9.04 | 0.25 | 1.56 | 0.06 | 0.77 | 2.14 | 462.6 | 459.0 |
| Example | | | | | | | | | | | | | | | |
| Example | 42 | D40 | 0.39 | 0.46 | 0.15 | 3.1 | 9.29 | 9.04 | 0.25 | 1.56 | 0.53 | 0.76 | 2.13 | 449.5 | 478.0 |
| Example | 43 | D41 | 0.39 | 0.46 | 0.15 | 3.1 | 9.36 | 9.11 | 0.26 | 1.54 | 0.95 | 0.71 | 2.09 | 407.4 | 487.7 |
| Example | 44 | D42 | 0.39 | 0.46 | 0.15 | 3.1 | 9.33 | 9.08 | 0.25 | 1.54 | 1.39 | 0.78 | 2.00 | 381.2 | 520.7 |
| Example | 45 | D43 | 0.39 | 0.46 | 0.15 | 3.1 | 9.35 | 9.10 | 0.25 | 1.54 | 1.40 | 0.80 | 1.81 | 376.3 | 503.4 |
| Example | 46 | D44 | 0.39 | 0.46 | 0.15 | 3.1 | 9.37 | 9.11 | 0.25 | 1.54 | 1.40 | 0.76 | 1.91 | 374.6 | 513.3 |
| Example | 47 | D45 | 0.39 | 0.46 | 0.15 | 3.1 | 9.29 | 9.04 | 0.25 | 1.56 | 2.38 | 3.60 | 0.46 | 401.7 | 511.4 |
| Comparative | 25 | D46 | 0.39 | 0.46 | 0.15 | 3.1 | 9.29 | 9.04 | 0.25 | 1.56 | 2.50 | 1.03 | 1.61 | 325.7 | 431.9 |
| Example | | | | | | | | | | | | | | | |

As shown in Table 5, even if aluminum oxide (Al₂O₃) was changed to a mixture of aluminum oxide (Al₂O₃) and chromium oxide (Cr₂O₃), the ferrite sintered magnets of D48 to D53 satisfying all constituent features of the present invention had a residual magnetic flux density Br of 355 mT or more and a coercive force HcJ of 482 kA/m or more.

TABLE 5

| | | | | | | | | | | | Al + Cr |
|---|---|---|---|---|---|---|---|---|---|---|---|
| | | | La | | | | | Fe | Co | La/Co | [L] |
| | | Sample | [x] | Ca | Sr | Ca/Sr | 12z | [(12 − y)z] | [yz] | x/yz | (mass %) |
| Comparative | 26 | D47 | 0.39 | 0.46 | 0.15 | 3.1 | 9.29 | 9.04 | 0.25 | 1.56 | 0.06 |
| Example | | | | | | | | | | | |
| Example | 48 | D48 | 0.39 | 0.46 | 0.15 | 3.1 | 9.29 | 9.04 | 0.25 | 1.56 | 0.53 |
| Example | 49 | D49 | 0.39 | 0.46 | 0.15 | 3.1 | 9.39 | 9.13 | 0.26 | 1.49 | 1.10 |
| Example | 50 | D50 | 0.39 | 0.46 | 0.15 | 3.1 | 9.40 | 9.15 | 0.25 | 1.55 | 1.16 |
| Example | 51 | D51 | 0.36 | 0.49 | 0.15 | 3.2 | 9.44 | 9.21 | 0.23 | 1.56 | 1.92 |
| Example | 52 | D52 | 0.36 | 0.49 | 0.15 | 3.2 | 9.41 | 9.19 | 0.23 | 1.57 | 2.07 |
| Example | 53 | D53 | 0.39 | 0.46 | 0.15 | 3.1 | 9.29 | 9.04 | 0.25 | 1.56 | 2.35 |
| Comparative | 27 | D54 | 0.39 | 0.46 | 0.15 | 3.1 | 9.29 | 9.04 | 0.25 | 1.56 | 2.50 |
| Example | | | | | | | | | | | |

| | | | | | | Magnetic Property | |
|---|---|---|---|---|---|---|---|
| | | Al₂O₃ | Cr₂O₃/4 | SiO₂ | | Br | HcJ |
| | | (mass %) | (mass %) | (mass %) | G | (mT) | (kA/m) |
| Comparative | 26 | 0.03 | 0.03 | 0.80 | 2.04 | 460.4 | 458.6 |
| Example | | | | | | | |
| Example | 48 | 0.27 | 0.26 | 0.75 | 2.13 | 449.5 | 482.4 |
| Example | 49 | 0.62 | 0.48 | 0.73 | 2.03 | 420.3 | 492.4 |
| Example | 50 | 0.46 | 0.70 | 0.77 | 1.90 | 403.4 | 502.7 |
| Example | 51 | 1.22 | 0.70 | 1.96 | 1.23 | 355.9 | 504.4 |
| Example | 52 | 1.22 | 0.85 | 3.40 | 0.44 | 366.1 | 499.7 |
| Example | 53 | 1.30 | 1.05 | 3.60 | 0.46 | 401.7 | 511.8 |
| Comparative | 27 | 1.25 | 1.25 | 1.75 | 0.78 | 330.6 | 417.4 |
| Example | | | | | | | |

As shown in Table 6, when sample D21 satisfying Ba/Sr≦0.2 is compared with sample D55 not satisfying Ba/Sr≦0.2 which has the same composition as D21 except for Ba/Sr ratio, sample D21 is superior to sample D55 in a residual magnetic flux density Br and a coercive force HcJ. Further, when sample D9 satisfying Ba/Sr sample D57 satisfying 0.2<Ba/Sr≦1.0 which has the same composition as D9 except for Ba/Sr ratio, and sample D58 not satisfying Ba/Sr≦1.0 which has the same composition as D9 except for Ba/Sr ratio are compared, residual magnetic flux density Br and coercive force HcJ are excellent in order from sample D9, sample D57, and sample D58. Also, when sample D34 (Ba/Sr=0) is compared with sample D56 (Ba/Sr=0.16) which is the same as D34 except for Ba/Sr ratio, both samples satisfying the condition of Ba/Sr≦0.2 have almost the same magnetic properties from the comprehensive viewpoint

TABLE 6

| | | | | | | | | | | | | Al₂O₃ | | | Magnetic Property | |
|---|---|---|---|---|---|---|---|---|---|---|---|---|---|---|---|---|
| | | Sam- | La | | | | | | Fe | Co | La/Co | [L] | SiO₂ | | Br | HcJ |
| | | ple | [x] | Ca | Sr | Ba | Ba/Sr | 12z | [(12 − y)z] | [yz] | x/yz | (mass %) | (mass %) | G | (mT) | (kA/m) |
| Example | 28 | D21 | 0.39 | 0.46 | 0.15 | 0.00 | 0.00 | 9.04 | 8.79 | 0.25 | 1.55 | 0.91 | 0.89 | 1.97 | 431.2 | 506.2 |
| Example | 54 | D55 | 0.39 | 0.46 | 0.08 | 0.07 | 0.83 | 9.04 | 8.79 | 0.25 | 1.55 | 0.91 | 0.89 | 1.97 | 401.0 | 484.6 |
| Example | 39 | D34 | 0.39 | 0.46 | 0.15 | 0.00 | 0.00 | 9.48 | 9.26 | 0.23 | 1.72 | 1.24 | 0.80 | 1.78 | 397.9 | 492.8 |
| Example | 55 | D56 | 0.39 | 0.46 | 0.13 | 0.02 | 0.15 | 9.48 | 9.26 | 0.23 | 1.72 | 1.24 | 0.80 | 1.78 | 389.9 | 492.1 |
| Example | 19 | D9 | 0.50 | 0.35 | 0.15 | 0.00 | 0.00 | 9.51 | 9.22 | 0.30 | 1.69 | 1.48 | 0.76 | 1.81 | 408.7 | 516.2 |
| Example | 56 | D57 | 0.50 | 0.35 | 0.08 | 0.07 | 0.88 | 9.51 | 9.22 | 0.30 | 1.69 | 1.48 | 0.76 | 1.81 | 367.8 | 480.2 |
| Example | 57 | D58 | 0.50 | 0.35 | 0.05 | 0.10 | 2.00 | 9.51 | 9.22 | 0.30 | 1.69 | 1.48 | 0.76 | 1.81 | 356.7 | 477.2 |

As shown in Table 7, ferrite sintered magnets of examples 58 to 61 having preferable composition of the main component as with C16 and corresponding to the four points of a, b, c and d in FIG. 2 showed a residual magnetic flux density Br of 330 mT or more and a coercive force HcJ of 477 kA/m or more and less than 500 kA/m. Also, ferrite sintered magnets of examples 62 to 65 corresponding to the four points of e, f, g, and h in FIG. 2 showed a residual magnetic flux density Br of 330 mT or more and a coercive force HcJ of 500 kA/m or more.

TABLE 7

| | | | | | | | | | | | Al₂O₃ | | | Magnetic Property | |
|---|---|---|---|---|---|---|---|---|---|---|---|---|---|---|---|
| | | | La | | | | | Fe | Co | La/Co | [L] | SiO₂ | | Br | HcJ |
| | | Sample | [x] | Ca | Sr | Ca/Sr | 12z | [(12 − y)z] | [yz] | x/yz | (mass %) | (mass %) | G | (mT) | (kA/m) |
| Example | 6 | C16 | 0.39 | 0.46 | 0.15 | 3.1 | 9.29 | 9.04 | 0.25 | 1.56 | 1.46 | 0.83 | 1.84 | 413.9 | 511.8 |
| Example | 58 | D59 | 0.39 | 0.46 | 0.15 | 3.1 | 9.29 | 9.04 | 0.25 | 1.56 | 0.20 | 0.69 | 2.30 | 401.3 | 478.0 |
| Example | 59 | D60 | 0.39 | 0.46 | 0.15 | 3.1 | 9.29 | 9.04 | 0.25 | 1.56 | 1.50 | 0.69 | 2.30 | 408.2 | 481.6 |
| Example | 60 | D61 | 0.39 | 0.46 | 0.15 | 3.1 | 9.29 | 9.04 | 0.25 | 1.56 | 2.15 | 5.21 | 0.30 | 412.8 | 493.2 |
| Example | 61 | D62 | 0.39 | 0.46 | 0.15 | 3.1 | 9.29 | 9.04 | 0.25 | 1.56 | 2.50 | 5.20 | 0.30 | 411.0 | 488.1 |
| Example | 62 | D63 | 0.39 | 0.46 | 0.15 | 3.1 | 9.29 | 9.04 | 0.25 | 1.56 | 0.55 | 0.79 | 2.00 | 415.8 | 501.0 |
| Example | 63 | D64 | 0.39 | 0.46 | 0.15 | 3.1 | 9.29 | 9.04 | 0.25 | 1.56 | 1.45 | 0.79 | 2.00 | 417.0 | 503.7 |
| Example | 64 | D65 | 0.39 | 0.46 | 0.15 | 3.1 | 9.29 | 9.04 | 0.25 | 1.56 | 2.20 | 4.00 | 0.40 | 400.3 | 500.2 |
| Example | 65 | D66 | 0.39 | 0.46 | 0.15 | 3.1 | 9.29 | 9.04 | 0.25 | 1.56 | 2.45 | 3.99 | 0.40 | 398.2 | 500.8 |

1. A ferrite magnetic material comprising a ferrite having a hexagonal crystal structure as a main component, wherein
metal element composition included in the main component is represented by the composition formula: RₓA₁₋ₓ(Fe_{12-y}Co_{y})_{z}, where
R is at least one element selected from the group consisting of La, Ce, Pr, Nd and Sm, and at least includes La,
A is at least two elements selected from the group consisting of Ca, Sr and Ba, and at least includes Ca and Sr, and
x, y and z satisfy the following conditions:
0.3≦x≦0.6;
8.0≦12z≦10.1; and
1.32≦x/yz≦1.96,
Si component and Al component and/or Cr component are included as a sub component in addition to the main component, and
L and G are values within a region surrounded by the points shown as a: (0.20, 2.30), b: (2.15, 0.30), c: (2.50, 0.30) and d: (1.50, 2.30) placed on (x, y) coordinate where said L and G are shown on x-axis and y-axis, respectively, wherein,
L is a sum of content (mass %) of Al component in terms of Al₂O₃ and a value obtained by dividing content (mass %) of Cr component in terms of Cr₂O₃ by four and
G is a value obtained by calculating the formula [(R+A)−(Fe+Co)/12]/Si where R, A, Fe, Co and Si indicate values of each atom % thereof.

2. The ferrite magnetic material as set forth in claim 1, wherein 1.8≦Ca/Sr≦3.7 is satisfied with respect to A in the composition formula.

3. The ferrite magnetic material as set forth in claim 1, wherein Ba/Sr≦2.0 is satisfied with respect to A in the composition formula.

4. A ferrite sintered magnet comprising a ferrite having a hexagonal crystal structure as a main component, wherein
metal element composition included in the main component is represented by the composition formula: RₓA₁₋ₓ(Fe_{12-y}Co_{y})_{z}, where
R is at least one element selected from the group consisting of La, Ce, Pr, Nd and Sm, and at least includes La,
A is at least two elements selected from the group consisting of Ca, Sr and Ba, and at least includes Ca and Sr, and
x, y and z satisfy the following conditions:
0.3≦x≦0.6;
8.0≦12z≦10.1; and
1.32≦x/yz≦1.96,
Si component and Al component and/or Cr component are included as a sub component in addition to the main component, and
L and G are values within a region surrounded by the points shown as a: (0.20, 2.30), b: (2.15, 0.30), c: (2.50, 0.30) and d: (1.50, 2.30) placed on (x, y) coordinate where said L and G are shown on x-axis and y-axis, respectively, wherein,
L is a sum of content (mass %) of Al component in terms of Al₂O₃ and a value obtained by dividing content (mass %) of Cr component in terms of Cr₂O₃ by four and
G is a value obtained by calculating the formula [(R+A)−(Fe+Co)/12]/Si where R, A, Fe, Co and Si indicate values of each atom % thereof.

5. The ferrite sintered magnet as set forth in claim 4, wherein 1.8≦Ca/Sr≦3.7 is satisfied with respect to A in the composition formula.

6. The ferrite sintered magnet as set forth in claim 4, wherein Ba/Sr≦2.0 is satisfied with respect to A in the composition formula.

7. A motor with the ferrite sintered material as set forth in claim 4.
